(19) United States
(12) Patent Application Publication
(10) Pub. No.: US 2005/0193635 A1
(43) Pub. Date: Sep. 8, 2005

(54) Reinforcing carrier, weatherstrip including such a reinforcing carrier and method of fabricating such a weatherstrip

(75) Inventor: Stephan Hemauer, Achberg (DE)

Correspondence Address: Stephen B. Salai, Esq.;Harter, Secrest & Emery LLP, 1600 Bausch & Lomb Place, Rochester, NY, 14604-2711, US

(73) Assignee: Metzeler Automotive Profile Systems GmbH, Lindau/Bodensee (DE)

(21) Appl. No.: 11/115,611

(22) Filed: Apr. 27, 2005

(30) Foreign Application Priority Data
Apr. 28, 2000 (DE) 10 2004 020 857.3

(51) Int. Cl. E06B 7/16

(52) U.S. Cl. 49/490.1

(57) ABSTRACT

A reinforcing carrier, serving particularly to strengthen an elastomeric weatherstrip (10) comprises a first flanking portion (21), a second flanking portion (23) and a middle portion (22) extending parallel in a longitudinal direction (x) and having in each case a width (b₁, b₂, b₃) in a transverse direction (y) perpendicular to the longitudinal direction (x). The middle portion (22) connects the first flanking portion (21) and the second flanking portion (23) in the transverse direction (y). The first flanking portion (21), and/or second flanking portion (23) and/or the middle portion (22) have a plurality of perforations (24, 25, 26) each comprising a closed circumference and having in the transverse direction (y) a first diameter (d₁) and in the longitudinal direction (x) a second diameter (d₂). To eliminate use of an adhesion promoter detrimental to the environment when embedding the reinforcing carrier in the weatherstrip 10 the ratio of the first diameter (d₁) to the width (b₁, b₂, b₃) is maximally 1:5.

### CROSS-REFERENCE TO RELATED APPLICATIONS

This application claims priority to German Application No. 10 2004 020 857.3-12, filed Apr. 28, 2004, entitled Reinforcing Carrier, Weatherstrip Including such a Reinforcing Carrier and Method of Fabricating such a Weatherstrip, which is hereby incorporated by reference.

### STATEMENT REGARDING FEDERALLY SPONSORED RESEARCH OR DEVELOPMENT

Not Applicable.

### REFERENCE TO A “SEQUENCE LISTING”

Not applicable.

### BACKGROUND OF THE INVENTION

1. Field of the Invention

The invention relates to a reinforcing carrier, serving particularly to strengthen an elastomeric weatherstrip. The reinforcing carrier is provided with a first flanking portion, a second flanking portion and a middle portion extending parallel in a longitudinal direction and has in each case a width in a transverse direction perpendicular to the longitudinal direction. The middle portion connects the first flanking portion and the second flanking portion in the transverse direction. The first flanking portion, second flanking portion and/or the middle portion comprise a plurality of perforations each comprising a closed circumference and in the transverse direction have a first diameter and in the longitudinal direction a second diameter. The invention relates furthermore to a weatherstrip as used particularly on motor vehicles which is provided with a fastening portion mountable on a first component, and at least one sealing portion by which a second component is sealable. In addition, the invention relates to a method of fabricating such a weatherstrip.

2. Description of Related Art

A bracing (metal) insert of the aforementioned kind is described in DE 40 27 191 A1. This known reinforcing carrier serves to strengthen an elastomeric weatherstrip composed of a fastening portion and a sealing portion in the region of the fastening portion to ensure satisfactory fastening of the weatherstrip by mounting the fastening portion on a flange. The reinforcing carrier with its U-shaped cross-section comprises two flanking portions and a middle portion interconnecting the two flanking portions. The flanking portions comprise incisions extended from the free end of the flanking portions up into the middle portion. The middle portion is provided with perforations which unlike the incisions have a closed circumference. The perforations and incisions are arranged alternating in the longitudinal direction of the reinforcing carrier, the perforations extending over practically the full width of the middle portion and partly into one of the flanking portions. The incisions permit bending the reinforcing carrier when required by the shape of the flange on which the weatherstrip is mounted, whereas the perforations permit extending the reinforcing carrier longitudinally to bias the weatherstrip. It is this bias that prevents the weatherstrip from wrinkling or creasing when bent.

A reinforcing carrier serving to strengthen a weatherstrip and provided with incisions and perforations ensuring adequate shaping compliance of the reinforcing carrier when the weatherstrip is bent, is disclosed in addition by DE 86 22 471 U1, DE 37 43 970 A1, DE 37 43 971 A1 and DE 199 02 543 A1. Common to all of these reinforcing carriers known from these patents is that the arrangement and configuration of the incisions and perforations primarily serves to render the reinforcing carriers compliable in shape for satisfactory bending, elongation or retraction. Likewise common to all of these reinforcing carriers is that during fabrication they are embedded in the weatherstrip which is usually extruded. A further aspect as is usually taken into account when configuring the reinforcing carriers is avoiding so-called chatter marks resulting, as a rule, due to contraction of the weatherstrip in the region of the incisions and perforations.

### BRIEF SUMMARY OF THE INVENTION

As regards their original function of strengthening a weatherstrip, known reinforcing carriers are usually made of metal. To attain a satisfactory bond between a metal reinforcing carrier and an elastomeric weatherstrip, adhesion promoters are employed which need to be attached to the reinforcing carrier before extruding the weatherstrip. Employing adhesion promoters increases the costs of production, for one thing, and, for another, is detrimental to the environment.

The invention is based on the object of providing a reinforcing carrier which eliminates having to employ adhesion promoters detrimental to the environment. Also claimed is a weatherstrip provided with such a reinforcing carrier, and a method of fabricating such a weatherstrip.

To achieve this object in a reinforcing carrier having the features as aforementioned, it is provided for that the ratio of the first diameter to the width is maximally 1:5 in accordance with the invention as set forth in claim 1.

The reinforcing carrier in accordance with the invention is the result of having discovered the advantage of perforating the flanking portions and/or the middle portion with relatively small perforations resulting in reinforcing carrier and elastomer being keyed when extruding an elastomeric weatherstrip. It is this keying that ensures a satisfactory bond between the reinforcing carrier and the weatherstrip in thus eliminating the need for an adhesion promoter. Tests indicate that keying is satisfactory when the ratio of the first diameter of the perforations to the width of the flanking portions or middle portion is maximally 1:5, in other words when the width is at least five-times larger than the first diameter. Because of their small dimensions, the perforations, machined expediently by punching or drilling, can be basically provided in any conventional reinforcing carrier in addition to any existing incisions and recesses.

Advantageous aspects of the reinforcing carrier in accordance with the invention are defined in claims 2 to 9.

Thus, in view of the relatively small dimensions of the perforations, it has been discovered to be of advantage when the ratio of the first diameter to the width is smaller than 1:10, preferably smaller than 1:20. In this case it is furthermore of advantage when the ratio of the first diameter to the second diameter is approximately 1:1. Dimensioning the perforations is in this case roughly the same in the transverse direction and in the longitudinal direction.

In one preferred embodiment of the reinforcing carrier in accordance with the invention the first diameter and/or the second diameter is in the range 0.1 mm to 5.0 mm, preferably in the range 0.5 mm to 1.0 mm. With a first diameter of, for example, 0.5 mm and a width of the flanking portions or of the middle portion of, for example, sealing lip 15 mm the ratio of first diameter to the width is 1:30.

Preferably the perforations are circular or polygonal, preferably square or triangular. Circular perforations are expediently machined by drilling, whereas, for example, square perforations are best achieved by punching.

In another preferred embodiment of the reinforcing carrier in accordance with the invention the first flanking portion and/or the second flanking portion and/or the middle portion comprise at least one row of perforations extending in the longitudinal direction. The perforations of a row are advantageously arranged spaced away from each other, the ratio of the spacing to the second diameter being at least 1:1. A small spacing between the perforations permits a large number of perforations in thus promoting satisfactory keying.

To ensure adequate shaping compatibility of the reinforcing carrier, the first flanking portion and/or the second flanking portion and/or the middle portion comprise a plurality of incisions extending in the transverse direction. Preferably the perforations and incisions are arranged alternating in the longitudinal direction, one incision alternating with at least one perforation in thus making it possible, depending on the particular application, to arrange for one incision alternating with a predefined number of perforations.

To achieve the cited object a weatherstrip is also proposed in claim 10 which comprises a fastening portion mountable on a first component, and at least one sealing portion by which a second component is sealed. The first component may be, for example, a flange on the body of a motor vehicle, whereas the second component is a windowpane, for example. The fastening portion is strengthened by the reinforcing carrier in accordance with the invention. The reinforcing carrier in accordance with the invention now makes it possible to eliminate use of an adhesion promoter in fabricating the weatherstrip.

Proposed furthermore in achieving the aforementioned object as it reads from claim 12 is a method of fabricating a weatherstrip, characterized by a reinforcing carrier being surrounded by an elastomer, for example when extruding the weatherstrip, without the assistance of an adhesion promoter.

### BRIEF DESCRIPTION OF THE SEVERAL VIEWS OF THE DRAWING(S)

Details and further advantages of the present invention read from the following description of a preferred example embodiment as shown merely diagrammatically in the corresponding drawings in which:

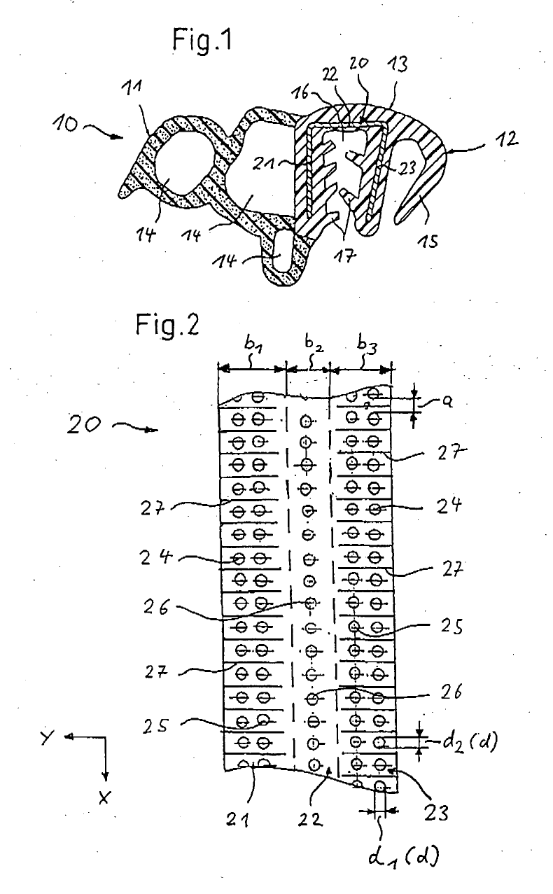

(a) FIG. 1 is a cross-section through a weatherstrip, strengthened by means of a reinforcing carrier, and

(b) FIG. 2 is a view from above on the reinforcing carrier as shown in FIG. 1 in a flat condition.

### DETAILED DESCRIPTION OF THE INVENTION

Referring now to FIG. 1 there is illustrated a weatherstrip 10 serving, for example, to weatherseal the windowpane or door of a motor vehicle. For this purpose the weatherstrip 10 comprises a first sealing portion 11, a second sealing portion 12 and a fastening portion 13 disposed between the first sealing portion 11 and second sealing portion 12. The first sealing portion 11 comprises a plurality of hollow chambers 14 and is made of a relatively soft elastomer, for example sponge rubber. The second sealing portion 12 is formed by a sealing lip 15 which, like the fastening portion 13, is made of an elastomer harder than that of the first sealing portion 11. The sealing portions 11, 12 and fastening portion 13 can be fabricated, for example, by coextrusion.

The fastening portion 13 is comprises a channeled recess 16, on the sidewalls of which holding lips 17 are arranged. Because of this recess 16 the fastening portion 13 can be mounted on a flange (not shown) of a motor vehicle door, for instance. Satisfactorily securing the fastening portion 13 on the flange is promoted, for one thing, by the holding lips 17 holding the fastening portion 13 non-positively and, where necessary, positively on the flange, and, for another, by a reinforcing carrier 20 of U-shaped cross-section surrounding the recess 16. The reinforcing carrier 20 ensuring adequate dimensional stability of the fastening portion 13 is composed of a first flanking portion 21, a middle portion 22 and a second flanking portion 23.

Referring now to FIG. 2 there is illustrated how in the reinforcing carrier 20 with non-downswept flanking portions 21, 23 the first flanking portion 21, middle portion 22 and second flanking portion 23 are oriented in a longitudinal direction x of the weatherstrip 10 parallel to each other, the middle portion 22 joining the flanking portions 21, 23 to each other in a transverse direction y perpendicular to the longitudinal direction x. It is furthermore evident from FIG. 2 that the reinforcing carrier 20 is machined from a flat strip, of metal as a rule, with the flanking portions 21, 23 downswept from the middle portion 22.

Both the flanking portions 21, 23 and the middle portion 22 are perforated with perforations 24, 25, 26, each of which has a closed circumference with a first diameter d₁ in the transverse direction y and a second diameter d₂ in the longitudinal direction x. Because of the perforations 24, 25, 26 being configured circular in this case, as machined, for example, by drilling or punching the strip as shown in FIG. 2, the first diameter d₁ is the same as the second diameter d₂ and thus corresponds to the diameter d of the perforations 24, 25, 26. Depending on the particular application, the perforations 24, 25, 26 may also be configured polygonal, for example, triangular in having particularly a second diameter d₂ different to the first diameter d₁.

The diameter d of the perforations 24, 25, 26 can be in the range 0.1 mm to 5.0 mm, it being in the present case 0.75 mm. The width b₁ of the first flanking portion 21 and the width b₃ of the second flanking portion 23 is in the present case approximately 25 mm in each case, whereas the width b₂ of the middle portion 22 is approximately 20 mm. The ratio of the diameter d of the perforations 24, 25 in the region of the flanking portions 21, 23 to the width b₁, b₃ of the flanking portions 21, 23 is thus approximately 0.03 or 3:100 in each case. The ratio of the diameter d of the perforations 26 in the region of the middle portion 22 to the width b₂ of the middle portion 22 is 0.035 or 3:80. Both in the region of the flanking portions 21, 23 and in the region of the middle portion 22 the ratio of the diameter d of the perforations 24, 25, 26 to the width b₁, b₂, b₃ is thus smaller than 0.05 or 1:20.

As furthermore evident from FIG. 2, the perforations 24, 25, 26 are arranged in a row extending in the longitudinal direction x. Each of the flanking portions 21, 23 comprises an outer row of perforations 24 and an inner row of perforations 25, whereas the middle portion 22 comprises a middle row of perforations 26. The perforations 24, 25, 26 of a row are spaced away from each other by a spacing a of, for example 1.5 mm. The ratio of the spacing a to the diameter d of the perforations 24, 25, 26 is thus 2:1.

The first flanking portion 21 and second flanking portion 23 are each provided with a plurality of incisions 27 extending in the transverse direction y from the free end of the flanking portions 21, 23 to just before the middle portion 22. The incisions 27 ensuring adequate shaping compatibility of the reinforcing carrier 20 may also extend partly into the middle portion 22, if needed, as is known for example from DE 86 22 471 U1. The perforations 24, 25 and incisions 27 are arranged alternating in the longitudinal direction x, i.e. an incision 27 alternating with a perforation 24, 25.

The reinforcing carrier 20 as described above is characterized by a plurality of perforations 24, 25, 26 having a diameter d which as compared to the dimensions of the reinforcing carrier 20 is small.

When extruding the weatherstrip 10, the relatively small dimensions of the perforations 24, 25, 26 result in good keying between the reinforcing carrier 20 and the elastomer from which the weatherstrip 10 is extruded. This assures a satisfactory bond between the fastening portion 13 and reinforcing carrier 20, eliminating the need for an adhesion promoter, which, as a rule, is detrimental to the environmental, in accordingly making the method kind to the environment.

1. A reinforcing carrier, serving particularly to strengthen an elastomeric weatherstrip, comprising a first flanking portion, a second flanking portion and a middle portion extending parallel in a longitudinal direction and having in each case a width in a transverse direction perpendicular to the longitudinal direction, the middle portion connecting the first flanking portion and the second flanking portion in the transverse direction, the first flanking portion and/or the second flanking portion and/or the middle portion having a plurality of perforations; the perforations comprising a closed circumference and having in the transverse direction a first diameter and in the longitudinal direction a second diameter, wherein the ratio of the first diameter to the width is maximally 1:5.

2. The reinforcing carrier as set forth in claim 1, wherein the ratio of the first diameter to the width is smaller than 1:10, preferably smaller than 1:20.

3. The reinforcing carrier as set forth in claim 1, wherein the ratio of the first diameter to the second diameter is approximately 1:1.

4. The reinforcing carrier as set forth in claim 1, wherein the first diameter and/or the second diameter are in the range of 0.1 mm to 5.0 mm, preferably in the range of 0.5 mm to 1.0 mm.

5. The reinforcing carrier as set forth in claim 1, wherein the perforations are circular or polygonal, preferably square or triangular.

6. The reinforcing carrier as set forth in claim 1, wherein the first flanking portion and/or the second flanking portion and/or the middle portion comprise at least one row of perforations extending in the longitudinal direction.

7. The reinforcing carrier as set forth in claim 6, wherein the perforations of one row are arranged spaced away from each other, the ratio of the spacing to the second diameter being at least 1:1.

8. The reinforcing carrier as set forth in claim 1, wherein the first flanking portion and/or the second flanking portion and/or the middle portion comprise a plurality of incisions extending in the transverse direction.

9. The reinforcing carrier as set forth in claim 8, wherein the perforations and the incisions are arranged alternating in the longitudinal direction, one incision alternating with at least one perforation.

10. A weatherstrip, particularly for a motor vehicle, comprising a fastening portion mountable on a first component, and at least one sealing portion for sealing a second component, wherein the fastening portion is strengthened by a reinforcing carrier comprising a first flanking portion, a second flanking portion and a middle portion extending parallel in a longitudinal direction and having in each case a width in a transverse direction perpendicular to the longitudinal direction, the middle portion connecting the first flanking portion and the second flanking portion in the transverse direction, the first flanking portion and/or the second flanking portion and/or the middle portion having a plurality of perforations; the perforations comprising a closed circumference and having in the transverse direction a first diameter and in the longitudinal direction a second diameter, wherein the ratio of the first diameter to the width is maximally 1:5.

11. The weatherstrip as set forth in claim 10, wherein the fastening portion comprises a channel-shaped recess, the reinforcing carrier surrounding the recess.

12. A method of fabricating a weatherstrip as set forth in claim 10, wherein the reinforcing carrier is surrounded by an elastomer without the assistance of an adhesion promoter.

13. The method as set forth in claim 12, wherein the elastomer is a thermoplastic elastomer or ethylene propylene diene monomer.

14. The method as set forth in claim 12, wherein the perforations of the reinforcing carrier are machined by drilling or punching.
